(19) United States
(12) Patent Application Publication
(10) Pub. No.: US 2012/0045707 A1
(43) Pub. Date: Feb. 23, 2012

(54) ANODE SUPPORTED FLAT-TUBE SOFC AND MANUFACTURING METHOD THEREOF

(75) Inventors: Rak-Hyun Song, Seoul (KR); Seung-Bok Lee, Seoul (KR); Seok-Joo Park, Daejeon (KR); Tak-Hyung Lim, Daejeon (KR); Jong-Won Lee, Daejeon (KR); Dong-Ryul Shin, Daejeon (KR); Seuk-Hoon Pi, Seoul (KR); Wan-Je Kim, Seoul (KR); Eun-Gu Kim, Seoul (KR)

(73) Assignee: KOREA INSTITUTE OF ENERGY RESEARCH, Daejeon (KR)

(21) Appl. No.: 13/008,370

(22) Filed: Jan. 18, 2011

(30) Foreign Application Priority Data
Aug. 19, 2010 (KR) 10-2010-0080353

(51) Int. Cl. H01M 8/24; H01M 8/00

(52) U.S. Cl. 429/455; 429/535

(57) ABSTRACT

Disclosed is an anode supported flat-tube solid oxide fuel cell including: a stack including a plurality of unit cells layered therein, each of the unit cells having an anode support, wherein within the anode support, a flow path allowing a fuel gas to flow is formed, and on a surface of the anode support, an electrolyte, a cathode, and an interconnect layer are provided, wherein the interconnect layer positioned between the unit cells constituting the stack is formed by a paste obtained by mixing an electrical conductive material with glass, and on the interconnect layer formed by the paste, a metallic mesh for drawing out a current collection wire is disposed.

### BACKGROUND OF THE INVENTION

1. Field of the invention

The present invention relates to a solid oxide fuel cell (SOFC), from among fuel cells, which generates electricity by an electrochemical reaction of fuels and air at a high temperature of 600 to 1000° C. by using a solid-state ceramic as an electrolyte. More particularly, the present invention relates to an anode supported flat-tube SOFC and a manufacturing method thereof.

2. Description of the Prior Art

A solid oxide fuel cell (SOFC) is a fuel cell for generating electricity by an electrochemical reaction of fuels (H2, CO) and air (oxygen) at a high temperature of 600 to 1000° C. by using a solid-state ceramic as an electrolyte, and has an advantage in that it shows the highest electricity generation efficiency and a high economic efficiency in existing electricity generation technologies.

The SOFC includes an electrolyte and an electrode in a solid state, and thus can be manufactured as various types of cells such as a planar type cell or a tube type cell. Also, the SOFC is divided into an anode supported SOFC, a cathode supported SOFC, and an electrolyte supported SOFC, according to a support of a fuel cell.

The planar type SOFC has advantages such as high power density, high productivity, and electrolyte thinning capability, but has a disadvantage of a requirement of gas sealing using an additional sealing material. Also, there is a problem in that since it uses a metallic interconnect layer at high temperatures, the efficiency of an electrode is reduced by the volatilization of chromium. Also, there is a disadvantage in that the reliability is insufficient due to low resistance against a thermal cycle. Furthermore, in a case of the planar type SOFC, it is difficult to manufacture a large-area cell, and also it is not easy to manufacture a high capability stack. Thus, the key point for practical use of the SOFC is to solve these problems.

The tube type SOFC does not require gas sealing, and shows high mechanical strength, and also has proved to have reliability in terms of various test items. Thus, it has been estimated as an SOFC design most close to commercial availability. However, the tube type SOFC has a disadvantage in that it has a high internal resistance and a low power density due to a long flow path of a current. Also, there is a weakness in that loss in power conversion during operation is high, thereby lowering the efficiency.

As described above, a conventional SOFC shows a technical limitation in high power, security of economic efficiency, and reliability. Thus, in order to overcome these problems, a flat-tube type SOFC has been suggested. The technology development on the flat-tube type SOFC is in active progress in such a manner that the flat-tube type SOFC employs only advantages of both the planar type SOFC and the tube type SOFC without the disadvantages.

### SUMMARY OF THE INVENTION

Accordingly, the present invention has been made to solve the technical limitations in a conventional solid oxide fuel cell (SOFC), and the present invention provides an anode supported flat-tube SOFC and a manufacturing method thereof, in which the manufacture of a stack is easy, current collection can be more simply carried out, a high performance is achieved, and a manufacturing cost can be reduced.

In accordance with an aspect of the present invention, there is provided an anode supported flat-tube SOFC including: a stack including a plurality of unit cells layered therein, each of the unit cells having an anode support, wherein within the anode support, a flow path allowing a fuel gas to flow is formed, and on a surface of the anode support, an electrolyte, a cathode, and an interconnect layer are provided, wherein the interconnect layer positioned between the unit cells constituting the stack is formed by a paste obtained by mixing an electrical conductive material with glass, and on the interconnect layer formed by the paste, a metallic mesh for current collection is disposed.

In the configuration, the paste preferably has a mixing ratio by weight of the electrical conductive material to the glass of 9:1 to 1:9.

Also, the interconnect layer is preferably formed by coating the paste with a thickness of 5 to 50 μm.

Also, the electrical conductive material may be one material selected from the group including Ag, Au, Pt, Ni, Co, W, Ti, Cu, Pd, Mn, Mo, and Si, or an alloy of two or more thereof, or may be a conductive ceramic material having a perovskite structure including one material selected from the group including La, Cr, Y, Ca, Ce, Ni, Fe, Ti, Cu, Mg, Ce, Sr, Mn, and Nd or a mixture of two or more thereof.

Also, the metallic mesh may include one material selected from the group including Ag, Au, and Pt, or a mixture of two or more thereof, or may include a metallic material selected from the group including Cr, Fe, Ni, C, Mn, Si, Cu, Al, Ti, La, and W, or an alloy of two or more thereof.

Furthermore, in order to facilitate the supply of a reaction gas, the metallic mesh preferably has a mesh size of 10 to 250.

Also, in the configuration, a plurality of the stacks are provided, and the plurality of the stacks may be disposed in parallel in such a manner that metallic meshes provided respectively in the stacks are connected in parallel to each other, or a plurality of the stacks are provided, and the plurality of the stacks may be disposed in series in such a manner that metallic meshes are connected in series to each other.

In accordance with another aspect of the present invention, there is provided a method for manufacturing an anode supported flat-tube SOFC, the method including the steps of: forming a unit cell by providing an electrolyte, a cathode, and an interconnect layer on a surface of an anode support; and forming a stack by layering a plurality of the unit cells, wherein the interconnect layer positioned between the unit cells constituting the stack is formed with a thickness of 5 to 50 μm by a paste obtained by mixing an electrical conductive material with glass in a mixing ratio by weight of 9:1 to 1:9, and is subjected to heat treatment at a softening point of the glass, and then on the interconnect layer, a metallic mesh for current collection is disposed

In the configuration, the electrical conductive material may be one material selected from the group including Ag, Au, Pt, Ni, Co, W, Ti, Cu, Pd, Mn, Mo, and Si, or an alloy of two or more thereof, or may be a conductive ceramic material having a perovskite structure including one material selected from the group including La, Cr, Y, Ca, Ce, Ni, Fe, Ti, Cu, Mg, Ce, Sr, Mn, and Nd or a mixture of two or more thereof.

Also, the metallic mesh may include one material selected from the group including Ag, Au, and Pt, or a mixture of two or more thereof, or may include a metallic material selected from the group including Cr, Fe, Ni, C, Mn, Si, Cu, Al, Ti, La, and W, or an alloy of two or more thereof.

Furthermore, the metallic mesh preferably has a mesh size of 10 to 250.

In the SOFC with the above described configuration, according to the present invention, in forming an interconnect layer positioned between unit cells constituting a stack, a paste obtained by mixing an electrical conductive material with glass is used, and on the interconnect layer, a metallic mesh is disposed to collect current. Thus, there is an advantage in that it is easy to manufacture a stack, and it is possible to more simply collect current.

Also, in the present invention, since a dense electrical conductive material is used to form an interconnect layer, it is possible to prevent a fuel gas from permeating into the interconnect layer. Thus, there is an advantage in that it is possible to improve the performance of the SOFC. Also, in the present invention, since a conventional expensive large-size metallic separating plate is not used, it is possible to reduce a manufacturing cost.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic view illustrating a part of a stack of an anode supported flat-tube solid oxide fuel cell (SOFC) according to the present invention;

FIG. 2a is a graph showing electrical conductivities according to used temperatures at an Ag to glass mixing ratio of 9:1 in the present invention;

FIG. 2b is a graph showing electrical conductivities according to used temperatures at Ag to glass mixing ratios of 8:2, 7:3, and 6:4 in the present invention;

FIG. 3a is a graph showing the performance of a fuel cell in a case where the thickness of a coated interconnect layer paste is less than 5 μm, unlike the present invention;

FIG. 3b is a graph showing the performance of a fuel cell in a case where the thickness of a coated interconnect layer paste is greater than 50 μm, unlike the present invention;

FIG. 4a is a graph showing the performance of a fuel cell according to the present invention;

FIG. 4b is a graph showing the performance of a conventional fuel cell, as compared to FIG. 4a;

FIG. 5 is a view illustrating the structure where stacks are layered in parallel in a fuel cell of the present invention;

FIG. 6 is a view illustrating the structure where stacks are layered in series in a fuel cell of the present invention;

FIG. 7 is a partially sectioned plan view illustrating a part of the stack shown in FIG. 1; and

FIG. 8 is a scanning electron microscope photograph showing an interconnect layer according to the present invention, in which the interconnect layer is formed by coating an Ag-glass mixed paste and carrying out heat treatment.

### DETAILED DESCRIPTION OF THE EXEMPLARY EMBODIMENTS

Hereinafter, a preferred exemplary embodiment of the present invention will be described in detail with reference to the accompanying drawings. However these exemplary embodiments described below are provided so that this disclosure can be sufficiently understood by those skilled in the art, and may be modified in various manners. The scope of the present invention is not limited by the exemplary embodiments.

A conventional planar type solid oxide fuel cell (SOFC) uses an expensive metallic separating plate in the formation of a stack. In other words, it has a limitation in selecting a material of a metallic component from among configuration components of a cell stack due to its high operating temperature, and thus requires selection of an expensive material having oxidation resistance so as to improve long-term performance at high temperatures. Furthermore, a gas channel and a gas-separation metallic separating plate, used for the planar type SOFC, require a high processing cost, thereby increasing a manufacturing unit cost of the SOFC. In order to solve these problems, an SOFC of the present invention employs a metallic mesh, instead of an expensive gas channel and an expensive gas-separation metallic separating plate.

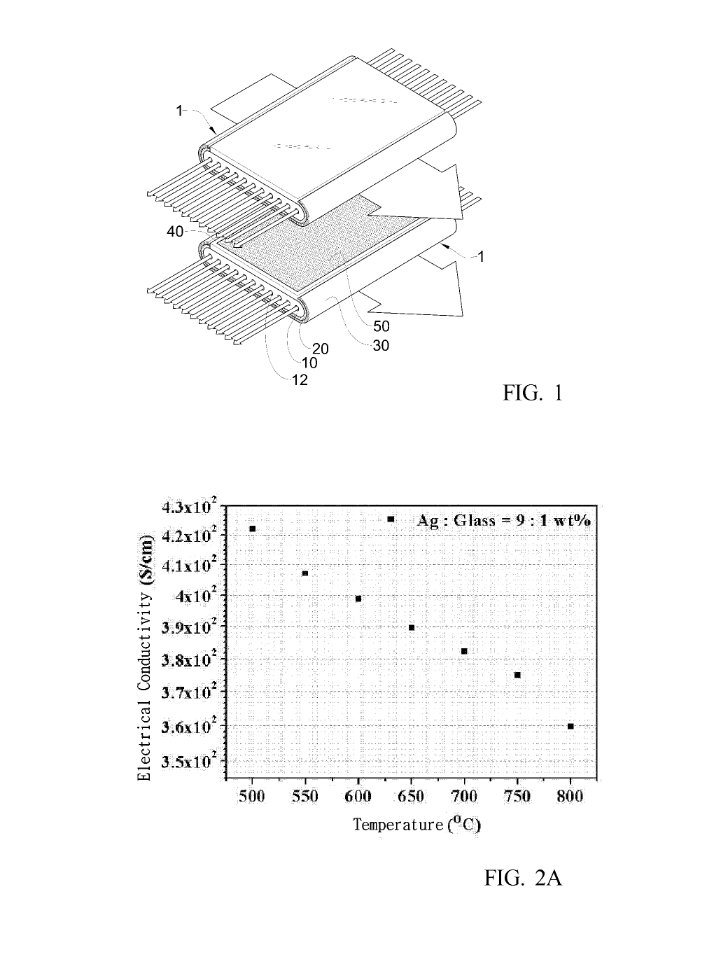

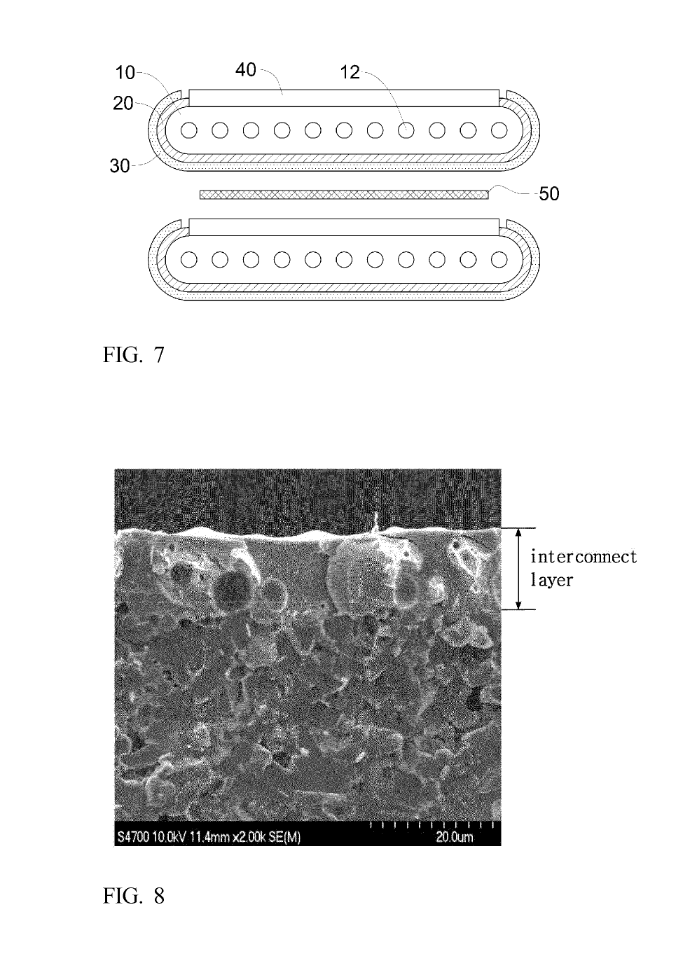

FIG. 1 is a schematic view illustrating a stack of an anode supported flat-tube SOFC according to the present invention, and FIG. 7 is a partially sectioned plan view illustrating a part of the stack shown in FIG. 1. The configuration is described as below.

First, a unit cell 1 constituting a fuel cell of the present invention includes an anode support 10, an electrolyte 20, a cathode 30, and an interconnect layer 40.

In the anode support 10, a flow path 12 is formed within which a fuel gas flows. On the surface of the anode support 10, the electrolyte 20 is coated, and on the surface of the electrolyte 20, the cathode 30 is coated. In sequentially coating the electrolyte 20 and the cathode 30 on the anode support 10, the anode support 10 is partially masked so as to leave a part on which the electrolyte 20, and the cathode 30 are not formed, and at the part, the interconnect layer 40 is directly formed on the anode support 10.

A plurality of the unit cells 1 configured as described above are layered to form a stack. The interconnect layer 40 positioned between unit cells 1 constituting the stack has to have a dense surface formed thereon so as to prevent a fuel injected into the anode support 10 from flowing toward the cathode 30, and has to have a high electrical conductivity at an operating temperature so as to prevent the performance from being reduced by a resistance of the interconnect layer 40 in formation of a stack. For this, in the present invention, an electrical conductive material and glass are mixed and made into a paste, and the paste is coated on the anode support 10 with a predetermined thickness through screen printing.

As the electrical conductive material, one material selected from the group including Ag, Au, Pt, Ni, Co, W, Ti, Cu, Pd, Mn, Mo, and Si, or a mixture of two or more thereof may be used. Also, a conductive ceramic material having a perovskite structure including one material selected from the group including La, Cr, Y, Ca, Ce, Ni, Fe, Ti, Cu, Mg, Ce, Sr, Mn, and Nd or a mixture of two or more thereof may be used. In the present embodiment, Ag is selected and used. Such an electrical conductive material shows a very high electrical conductivity, but has a disadvantage in that a dense surface cannot be formed. In order to overcome the disadvantage, the electrical conductive material is mixed with glass. In other words, glass not only performs a role of filling an empty space of the electrical conductive material-coated layer, but also increases the durability of the interconnect layer by inhibiting the movement of Ag.

The mixing ratio by weight of the electrical conductive material and glass preferably ranges from 9:1 to 1:9. The table 1 below exemplifies the mixing ratios of components for forming a paste.

TABLE 1

| | Component | 9:1 | | 8:2 | | 7:3 | | 6:4 | | 5:5 | | 4:6 | | 3:7 | | 2:8 | | 1:9 | |
|---|---|---|---|---|---|---|---|---|---|---|---|---|---|---|---|---|---|---|---|
| Powder | Ag | 18 | g | 16 | g | 14 | g | 12 | g | 10 | g | 8 | g | 6 | g | 4 | g | 2 | g |
| mixing | Glass | 2 | g | 4 | g | 6 | g | 8 | g | 10 | g | 12 | g | 14 | g | 16 | g | 18 | g |
| | Solvent | 5 | g | 5 | g | 5 | g | 5 | g | 5 | g | 5 | g | 5 | g | 5 | g | 5 | g |
| binder | Binder | 10 | g | 10 | g | 10 | g | 10 | g | 10 | g | 10 | g | 10 | g | 10 | g | 10 | g |
| composition | Solvent | 40 | g | 40 | g | 40 | g | 40 | g | 40 | g | 40 | g | 40 | g | 40 | g | 40 | g |
| Binder | — | 7.5 | g | 7.5 | g | 7.5 | g | 7.5 | g | 7.5 | g | 7.5 | g | 7.5 | g | 7.5 | g | 7.5 | g |
| Dispersant | — | 0.20 | g | 0.20 | g | 0.20 | g | 0.20 | g | 0.20 | g | 0.20 | g | 0.20 | g | 0.20 | g | 0.20 | g |

As mentioned above, the interconnect layer 40 has to satisfy two conditions including a high electrical conductivity, and formation of a very dense layer. Herein, the very dense layer has to be formed so that a fuel injected into the anode support cannot be permeated into oxygen atmosphere of the cathode 30's side through the interconnect layer 40.

However, if the mixing ratio of the electrical conductive material and glass is out of the above described range, the interconnect layer 40 cannot satisfy such two conditions, thereby reducing the performance of the fuel cell. For example, in a case where only pure Ag is used, the interconnect layer shows a high electrical conductivity, but cannot achieve the formation of a dense layer. Thus, glass is added thereto so as to solve such a problem.

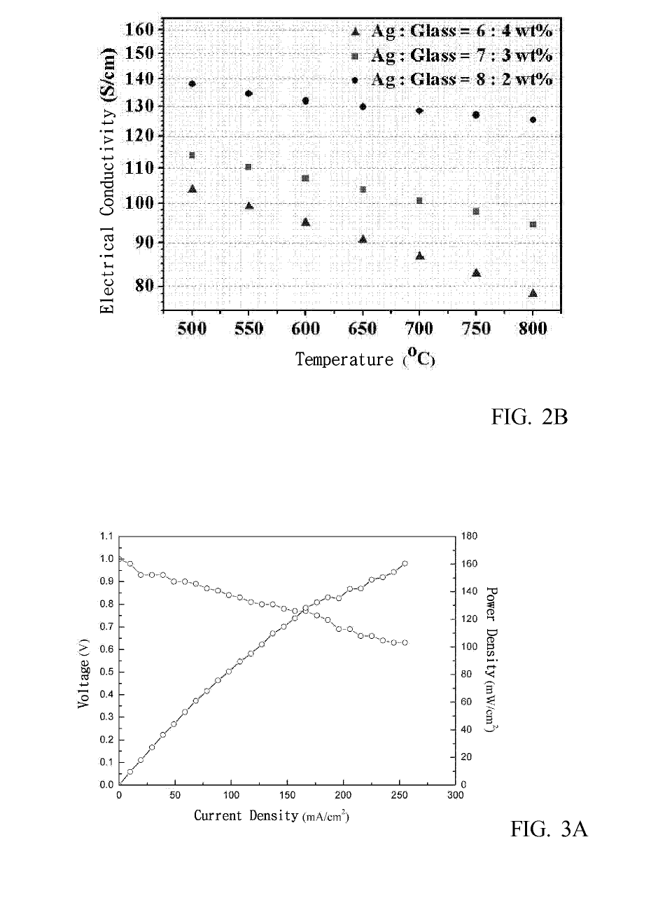

However, as the amount of added glass increases, the electrical conductivity decreases. Thus, the mixing ratio of the electrical conductive material and glass has to be maintained in a ratio of at least 1:9. FIGS. 2a and 2b, respectively, show electrical conductivities according to used temperatures in various mixing ratios of Ag and glass. As the electrical conductivity decreases, the performance of a fuel cell is reduced. Thus, it is preferable to select a mixing ratio with a high electrical conductivity. In the drawings, although data on a mixing ratio of Ag and glass ranges from 5:5 to 1:9 are not illustrated, in these mixing ratios, the electrical conductivity is 1 S/cm or more. Thus, when the electrical conductivity is 1 S/cm or more, the paste may be used for a fuel cell.

Also, the permeability of gas in the interconnect layer 40 has to be 1×10-6 L/S·cm²·atm or less. As a result of measuring the gas permeability by a bubble meter, for the Ag-to-glass mixing ratio of 9:1, the gas permeability was 1.8933 10-7 L/S·cm²·atm, and for the mixing ratio of 8:2 to 1:9, the gas permeability was 10-9 L/S·cm²·atm or less. From these results, it can be found that the mixtures in all ranges of the mixing ratio can be used as the interconnect layer.

Meanwhile, in order to satisfy the two conditions as the interconnect layer 40 (that is, an electrical conductivity, and formation of a dense layer), it is preferable to coat the paste with a thickness of 5 to 50 μm to form the interconnect layer 40. Also, the interconnect layer 40 has to be sintered by subjecting the coated paste to heat treatment at a softening point of the glass, so that a stable coated state can be maintained. The heat treatment temperature of the coated interconnect layer has to be the softening point or more of the added glass. It should be noticed that it is impossible to form a dense coating film when the heat treatment temperature is higher than the melting point of glass, or when the heat treatment time is too long. FIG. 8 is a scanning electron microscope photograph showing the interconnect layer 40, in which the interconnect layer is formed by coating an Ag-glass mixed paste as described above and carrying out heat treatment.

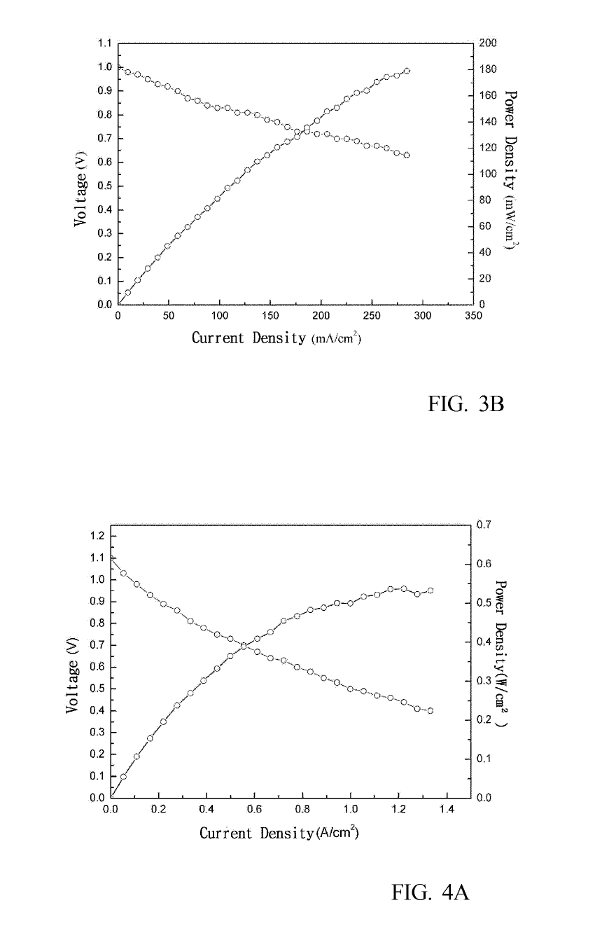

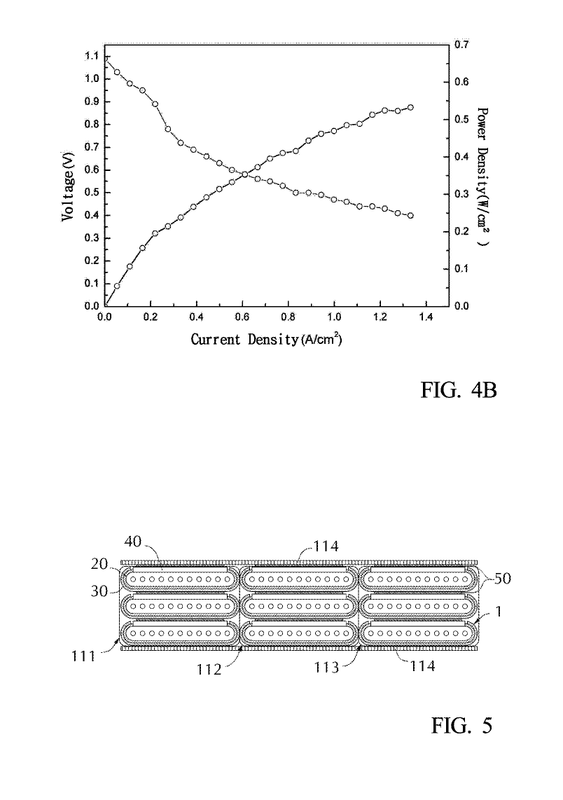

When the thickness of the coated paste is less than 5 μm, the performance of a fuel cell is reduced due to the difficulty in securing the gas permeability. On the other hand, when the thickness is greater than 50 μm, there is no problem in the gas permeability while the performance of a fuel cell is reduced due to an increase in the resistance. FIG. 3a shows the instable performance of a fuel cell, caused by a problem in gas sealing, in a case where the thickness of a coated paste is less than 5 μm, and FIG. 3b shows the performance of a fuel cell, in a case where the thickness of a coated paste is greater than 50 μm. From these drawings, it can be found that the performance of a fuel cell was reduced, as compared to FIG. 4a showing the performance of a fuel cell according to the present invention.

Then, after the interconnect layer 40 is formed by the paste obtained by mixing the electrical conductive material with glass as described above, a metallic mesh 50 for collecting current is disposed on the interconnect layer 40. As the metallic mesh 50, a metal, such as Ag, Au, Pt, or the like, may be used, or a metallic material containing one element selected from the group including Cr, Fe, Ni, C, Mn, Si, Cu, Al, Ti, La, and W, or an alloy of two or more thereof may be used. Also, the metallic mesh 50 is formed with a mesh size of 10 to 250. The mesh size is a limitation range which allows oxygen to reach the cathode 30 through diffusion via the metallic mesh. When the mesh size is greater than 250, the performance of a fuel cell is reduced due to the difficulty in permeability of oxygen gas.

FIGS. 4a and 4b, respectively, are graphs showing performances of a fuel cell according to the present invention, and a conventional fuel cell with no interconnect layer. The fuel cell according to the present invention, in which a metallic mesh is disposed on an interconnect layer formed through coating of a paste obtained by mixing an electrical conductive material with glass, was found to show high performance due to its power density higher than that of a conventional fuel cell with no interconnect layer.

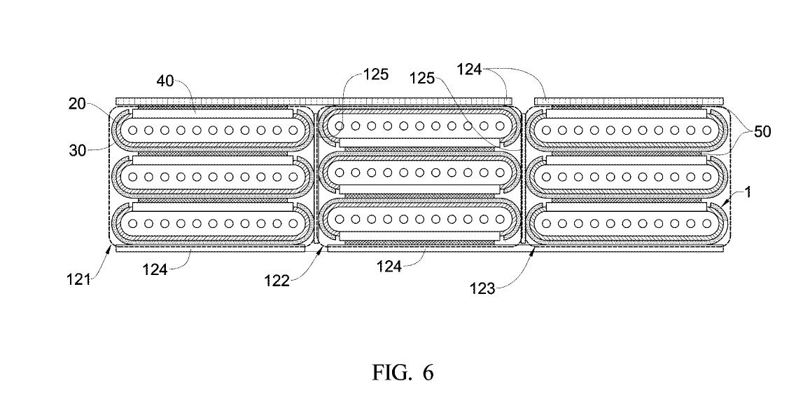

Meanwhile, FIGS. 5 and 6, respectively, are views illustrating a structure where stacks are layered in parallel, and a structure where stacks are layered in series, in a fuel cell of the present invention.

First, in the fuel cell shown in FIG. 5, three stacks 111, 112, and 113, in each of which three unit cells 1 are layered, are disposed. These stacks 111, 112, and 113, respectively, have a structure where they are disposed in parallel in the same direction. In other words, the stacks 111, 112, and 113 are disposed in parallel in such a manner that the metallic meshes 50 disposed between respective unit cells 1 constituting the stacks 111, 112, and 113 can be connected in parallel. Reference numeral 114 indicates a conductive material for connecting the stacks 111, 112, and 113 to each other, such as a wire or a metallic separating plate. A fuel cell including the stacks 111, 112, and 113 with such a parallel-layered structure is suitable as a fuel cell for high current.

In the structure of the fuel cell shown in FIG. 6, stacks 121, 122, and 123, in each of which the unit cells 1 are layered, are disposed in series in such a manner that the metallic meshes 50 can be connected in series to each other. Reference numeral 124 indicates a conductive material for connecting the stacks 121, 122, and 123 to each other, and reference numeral 125 indicates a porous insulator. The fuel cell including the stacks 121, 122, and 123 with such a serial-layered structure is suitable as a fuel cell for high voltage.

As described above, in the present invention, an interconnect layer positioned between unit cells constituting a stack is formed by a paste obtained by mixing an electrical conductive material with glass, and also, on the interconnect layer formed by the paste, a metallic mesh for current collection is disposed. Accordingly, a contact resistance and an ohm resistance between end cells can be minimized, and thus it is possible to simply collect current, compared to a case where a conventional interconnect layer is used. Furthermore, it is possible to obtain a flat-tube SOFC having high performance.

Although the present invention has been described with reference to a preferred exemplary embodiment thereof, the invention is not limited to the embodiment above, and various modifications can be made by those skilled in the art within the scope of the invention.

1. An anode supported flat-tube solid oxide fuel cell (SOFC) comprising:
a stack comprising a plurality of unit cells layered in series or in parallel therein, each of the unit cells having an anode support, wherein within the anode support, a flow path allowing a fuel gas to flow is formed, and on a surface of the anode support, an electrolyte, a cathode, and an interconnect layer are provided,
wherein the interconnect layer positioned between the unit cells constituting the stack is formed by a paste obtained by mixing an electrical conductive material with glass, and on the interconnect layer formed by the paste, a metallic mesh for current collection is disposed.

2. The anode supported flat-tube SOFC as claimed in claim 1, wherein the paste has a mixing ratio by weight of the electrical conductive material to the glass of 9:1 to 1:9.

3. The anode supported flat-tube SOFC as claimed in claim 1, wherein the interconnect layer is formed by coating the paste with a thickness of 5 to 50 μm.

4. The anode supported flat-tube SOFC as claimed in claim 1, wherein the electrical conductive material for the interconnect layer is one material selected from the group including Ag, Au, Pt, Ni, Co, W, Ti, Cu, Pd, Mn, Mo, and Si, or an alloy of two or more thereof.

5. The anode supported flat-tube SOFC as claimed in claim 1, wherein the electrical conductive material is a conductive ceramic material having a perovskite structure comprising one material selected from the group including La, Cr, Y, Ca, Ce, Ni, Fe, Ti, Cu, Mg, Ce, Sr, Mn, and Nd or a mixture of two or more thereof.

6. The anode supported flat-tube SOFC as claimed in claim 1, wherein the metallic mesh comprises one material selected from the group including Ag, Au, and Pt, or a mixture of two or more thereof.

7. The anode supported flat-tube SOFC as claimed in claim 1, wherein the metallic mesh comprises a metallic material selected from the group including Cr, Fe, Ni, C, Mn, Si, Cu, Al, Ti, La, and W, or an alloy of two or more thereof.

8. The anode supported flat-tube SOFC as claimed in claim 1, wherein the metallic mesh has a mesh size of 10 to 250.

9. The anode supported flat-tube SOFC as claimed in claim 1, wherein a plurality of the stacks are provided, wherein the plurality of the stacks are disposed in parallel in such a manner that metallic meshes provided respectively in the stacks are connected in parallel to each other.

10. The anode supported flat-tube SOFC as claimed in claim 1, wherein a plurality of the stacks are provided, wherein the plurality of the stacks are disposed in series in such a manner that metallic meshes provided respectively in the stacks are connected in series to each other.

11. A method for manufacturing an anode supported flat-tube SOFC, the method comprising the steps of:
forming a unit cell by providing an electrolyte, a cathode, and an interconnect layer on a surface of an anode support; and
forming a stack by layering a plurality of the unit cells in series or in parallel,
wherein the interconnect layer positioned between the unit cells constituting the stack is formed with a thickness of 5 to 50 μm by a paste obtained by mixing an electrical conductive material with glass in a mixing ratio by weight of 9:1 to 1:9, and is subjected to heat treatment at a softening point of the glass, and then on the interconnect layer, a metallic mesh for current collection is disposed.

12. The method as claimed in claim 11, wherein the electrical conductive material is one material selected from the group including Ag, Au, Pt, Ni, Co, W, Ti, Cu, Pd, Mn, Mo, and Si, or a mixture of two or more thereof.

13. The method as claimed in claim 11, wherein the electrical conductive material is a conductive ceramic material having a perovskite structure comprising one material selected from the group including La, Cr, Y, Ca, Ce, Ni, Fe, Ti, Cu, Mg, Ce, Sr, Mn, and Nd or a mixture of two or more thereof.

14. The method as claimed in claim 11, wherein the metallic mesh comprises one material selected from the group including Ag, Au, and Pt, or a mixture of two or more thereof.

15. The method as claimed in claim 11, wherein the metallic mesh comprises a metallic material selected from the group including Cr, Fe, Ni, C, Mn, Si, Cu, Al, Ti, La, and W, or an alloy of two or more thereof.

16. The method as claimed in claim 11, wherein the metallic mesh has a mesh size of 10 to 250.
